(19) United States
(12) Patent Application Publication
(10) Pub. No.: US 2005/0246927 A1
(43) Pub. Date: Nov. 10, 2005

(54) Electronic sign

(76) Inventor: Max Ferdinand Krawinkel, Bergneustdadt (DE)

Correspondence Address: Vasilios D. Dossas;NIRO, SCAVONE, HALLER & NIRO, Suite 4600, 181 West Madison Street, Chicago, IL, 60602, US

(21) Appl. No.: 10/839,557

(22) Filed: May 5, 2004

(51) Int. Cl. G09F 13/18; G09F 3/04

(52) U.S. Cl. 40/544; 40/451

(57) ABSTRACT

An electronic sign includes a frame, an illuminated body disposed on the frame with edge portions and at least one face, an illuminating member disposed along at least one edge portion of the illuminated body for illuminating the illuminated body, and readable indicia disposed opposite the one face of the illuminated body. The electronic sign may further include at least one panel with light emitting diodes disposed proximate the illuminated body.

### BACKGROUND OF THE INVENTION

1. Field of the Invention

The present invention relates to electronic signs, and more particularly to electronic signs with a back light system which does not include fluorescent lamps and ballasts.

2. Description of Prior Art

The prior art includes a variety of electronic signs that display indicia such as product price and grade information. One of those signs, an electronic scrolling sign, includes vinyl strips printed with numerals 0 to 9, a motor for driving the vinyl strips, and stationary plates made of plexiglass or polycarbonate printed with product grades. The motor moves the vinyl strips to make a price change; and fluorescent lamps disposed behind the vinyl strips and product plates make the numerals and product grades visible at night.

Another prior device is an electronic segment sign which includes a number of panel segments, a display surface, and various components such as motors that move the segments to and from the display surface to form numerals. This sign also includes plates made of metal, polycarbonate, or plexiglass printed with product grades and light sources such as fluorescent lamps to illuminate, at night, the numerals on the display surface and the product grades on the plates.

An electronic LED sign is yet another prior device. This prior sign includes a field of light emitting diodes that co-operate to form the numerals for the sign and plates of plexiglass printed with product grades and illuminated by fluorescent tubes. The diodes require a constant supply of power to illuminate the numbers that they form. The fluorescent lamps require additional power for illuminating the product grades at night.

The prior devices suffer a number of disadvantages. They include fluorescent lamps that require periodic replacement. The fluorescent lamps include ballasts that regulate current, stabilize light output, and also require periodic replacement. Motors used in the prior devices have limited life spans and thus require periodic replacement, as well. Finally, the fluorescent lamps and other components of the prior devices draw a great deal of energy, making the prior devices expensive to operate.

The electronic sign of the present invention avoids the disadvantages of the prior art devices. It eliminates the need for fluorescent lamps, ballasts and motors. It is a simple construction which minimizes the cost of manufacture, assembly and operation while providing consistent, reliable and effective display with components that maximize the life expectancy of the sign.

### SUMMARY OF THE INVENTION

In accordance with an embodiment of the present invention, an electronic sign includes a frame, an illuminated body disposed on the frame with edge portions and at least one face, an illuminating member disposed along at least one edge portion of the illuminated body for illuminating the illuminated body, and readable indicia disposed opposite the one face of the illuminated body. The electronic sign may further include at least one panel with light emitting diodes disposed proximate the illuminated body. Alternatively, the electronic sign may include a scrolling mechanism instead of the LED panel, an illuminated body and an illuminating member providing back lighting for the scrolling mechanism.

### BRIEF DESCRIPTION OF THE DRAWINGS

For a more complete understanding of this invention, one should now refer to the embodiment and modifications illustrated in greater detail in the accompanying drawings as described below as examples of the invention. In the drawings:

FIG. 1 is a front elevational view of a petroleum filling station price sign, including the present invention;

FIG. 2 is a partial front elevational view of the price sign of FIG. 1, including the present invention;

FIG. 3 is another partial front elevational view of the price sign of FIG. 1, including the present invention;

FIG. 4 is a sectional view taken along ling 4-4 in FIG. 3;

FIG. 5 is an exploded perspective view of a product information portion of the sign of the present invention;

FIG. 6 is a sectional view taken along line 6-6 in FIG. 5;

FIG. 7 is a detail view of a portion of the section shown in FIG. 6;

FIG. 8 is a detail view of another portion of the section shown in FIG. 6;

FIG. 9 is a front elevational view of an LED panel;

FIG. 10 is a back elevational view of the panel shown in FIG. 9;

FIG. 11 is a perspective of the sign shown in FIG. 3 with the bottom part opened; and

FIG. 12 is a perspective view of the LED panels, showing the back of the panels with their ribbon cable connections.

While the following disclosure describes the invention in connection with one embodiment and a number of modifications, one should understand that the invention is not limited to this embodiment and modifications. Furthermore, one should understand that the drawings are not to scale and that graphic symbols, diagrammatic representations, and fragmentary views, in part, may illustrate the embodiment and modifications. In certain instances, the disclosure may not include details which are necessary for an understanding of the present invention.

### DESCRIPTION OF THE DRAWINGS

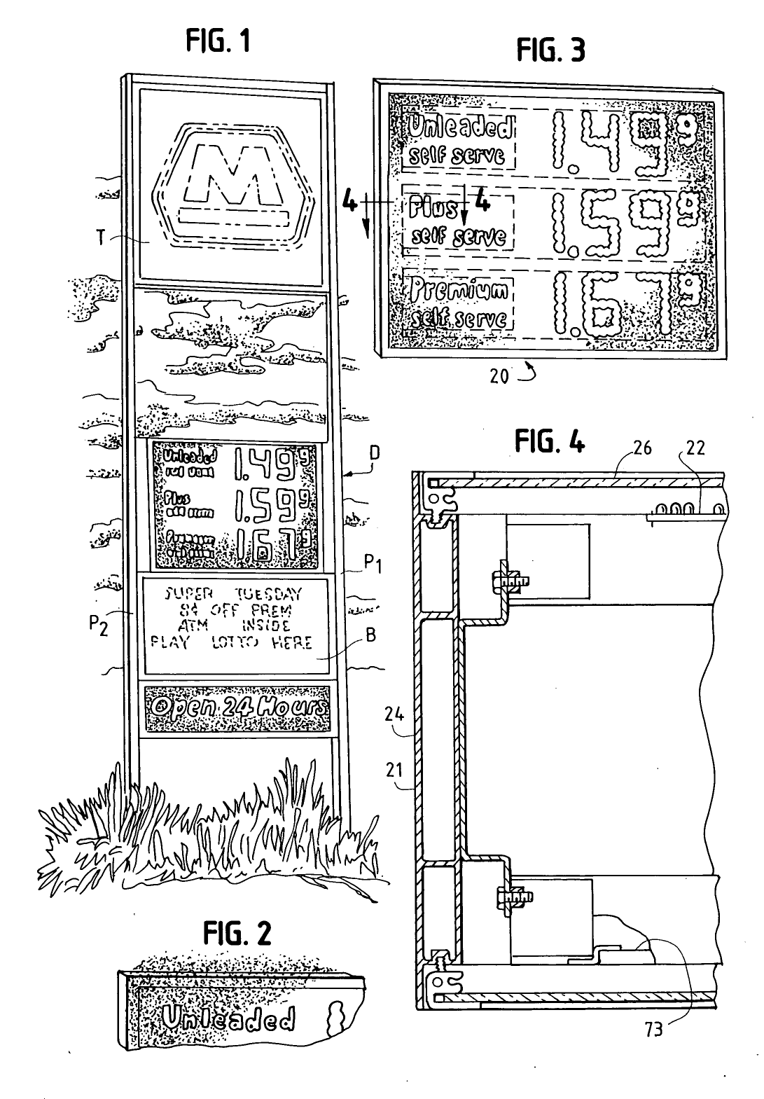

Turning now to the drawings and referring specifically to FIGS. 1-4, a petroleum filling station display D, includes two poles P₁ and P₂, a top display panel T, a bottom display panel B, and a pair of electronic signs 20 of the present invention disposed in back-to-back relation proximate the middle of the display. The electronic sign 20 generally includes a frame 21, a set of light emitting diode (LED) panels 22 and product grade display assemblies 23 for one side of the sign 20, and a second set of LED panels 22 and display assemblies 23 for another, opposite side of the sign 20.

One of the electronic signs 20 of the present invention appears in FIG. 3; and it includes three rows of LED panels that provide three numbers, representing, for example, three prices. It also includes three displays 23 adjacent the three rows of LED panels. In this example, the display 23 provides product information for the product (gas) associated with the three prices. The other sign 20 lies in back-to-back relation with the first sign 20 and has the same features that the first sign 20 has. (See FIG. 4)

In operation the LED panels require power to operated both day and night and display prices while the indicia of the product displays are visible during daylight without a power supply. The indicia includes letters or any other designs or images typically printed or otherwise formed on a transparent panel. During daytime the color of the indicia and the contrast between them and the transparent panel makes them visible. However, the product display 23 requires power at night to illuminate the product indicia.

The pair of electronic signs 20 include a frame or cabinet 21 which contains the assemblies 23 and the panels 22 and which includes a rectangular rim 24 made out of aluminum or any other suitable material of high strength and rigidity, a transparent panel 25 that closes one face of the rim 24, and a second transparent panel 26 that closes the opposite face of the rim. The rim 24 and the panels 25 and 26 define a water-tight box that contains the LED panels 22 and the display assemblies 23 and protects them from the elements and from pests such as insects.

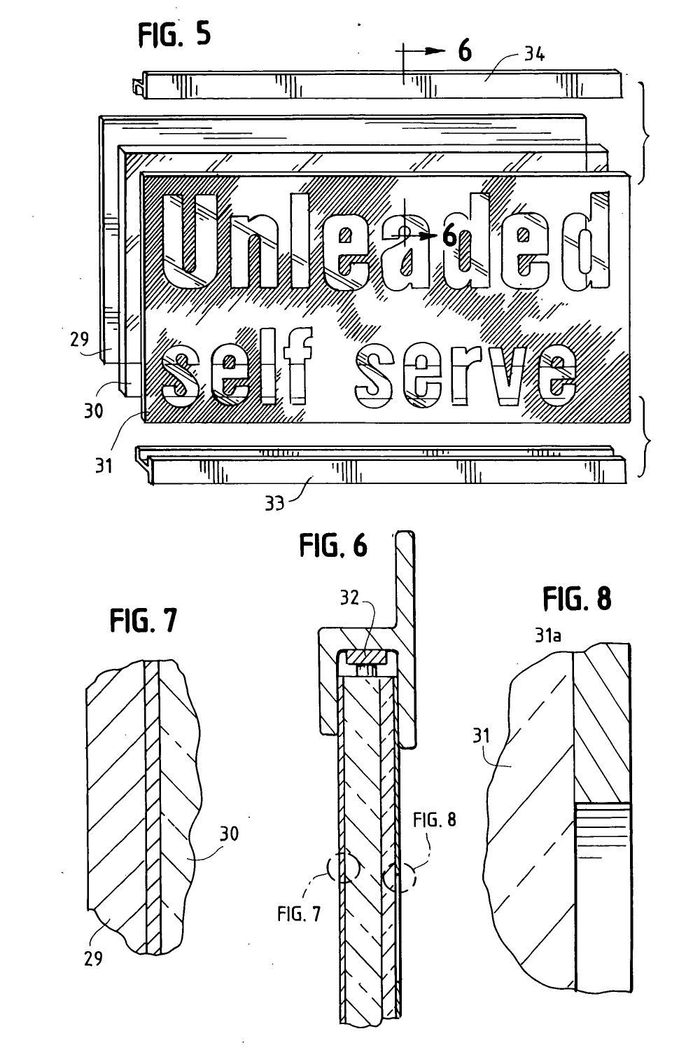

Each display assembly 23 includes a reflecting plate 29, an illuminated body 30, an indicia bearing cover plate 31, an illuminating member 32, and brackets 33 and 34 which secure these components together. (See FIGS. 5-8) The illuminating member 32 provides light to the body 30 which disperses it and, with the cooperation of the reflecting plate 29, directs it towards the cover plate 31, thus back-lighting the cover plate 31. The brackets 33 and 34 secure all these plate-like elements in abutting face-to-face relation. Alternatively, a moveable (e.g., scrolling strip may replace the stationary cover plate 31.

The illuminating member 32 includes a surface mounted diode that illuminates the body 30. This body 30 includes a translucent, white tinted plexiglass which receives the light from the surface mounted diode and disperses it. The reflecting plate 29 is made from a rigid material such as aluminum coated with a reflective material which reflects the light in the body 30 towards the cover plate 31 and evenly illuminates the plate; and the cover plate includes a transparent or translucent material such as plexiglass with indicia 31a such as letters and designs printed or otherwise formed on one of its surfaces.

Each of the signs 20 includes six of the display assemblies 23. Alternatively, the signs 20 may include any number of these assemblies 23, as well as any number of LED panels 22. In addition, the illuminating member 32 of each assembly 23 may include one surface mounted diode disposed along an edge of the body 30, a pair of surface mounted diodes disposed at opposite edges of the body 30, or more than two surface mounted diodes, depending on the configuration and size of the body 30.

By way of a specific example, an assembly 23 was constructed with a plexiglass body 30 (Plexiglas GS 1002L manufactured by Roehm of Germany) having a thickness of 2.36 inches, a reflecting plate 31 made of aluminum with a thickness of 0.11 to 0.19 inches and coated with a white color, and a cover plate 31 made of plexiglass with a thickness of 0.59 inches and screen printed with product designations.

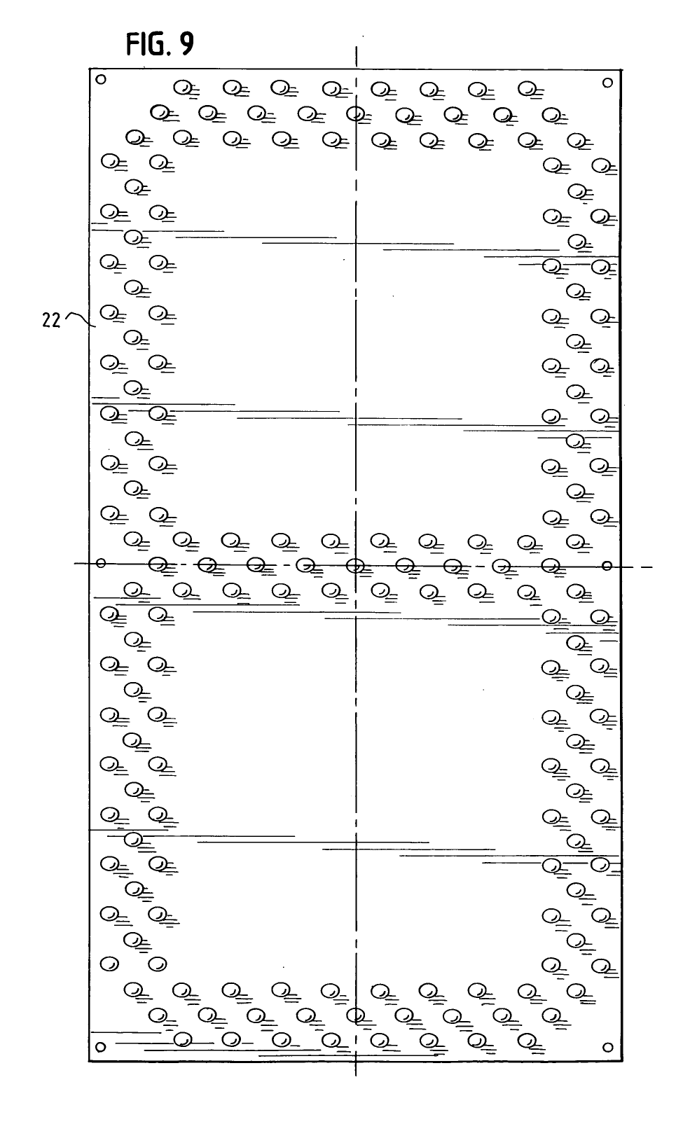

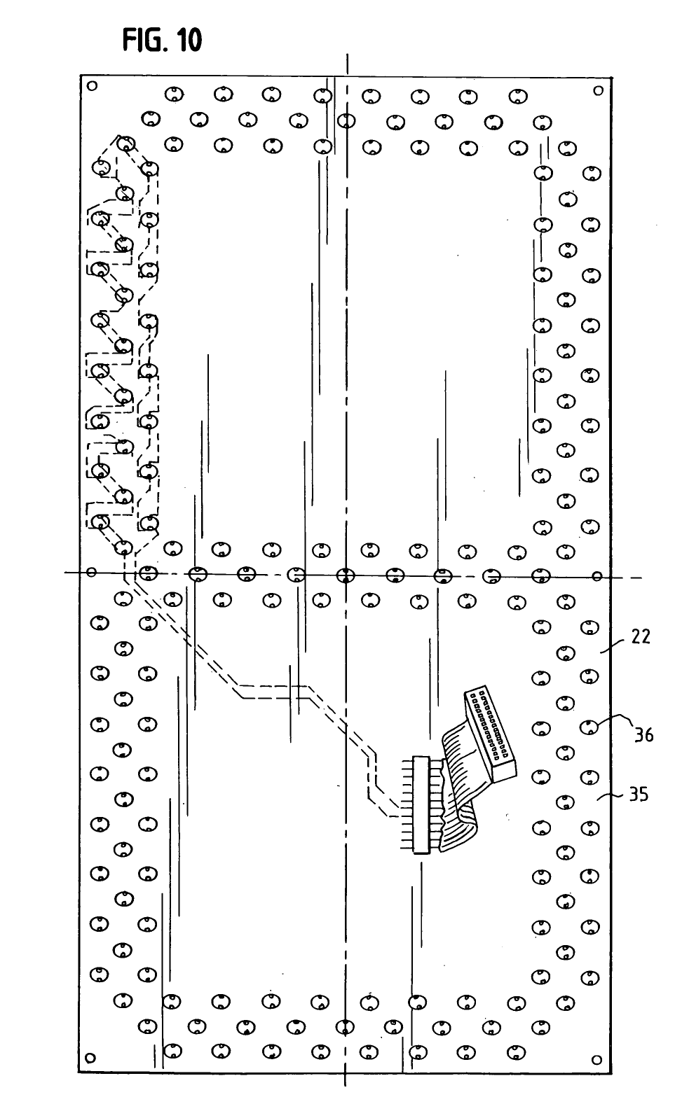

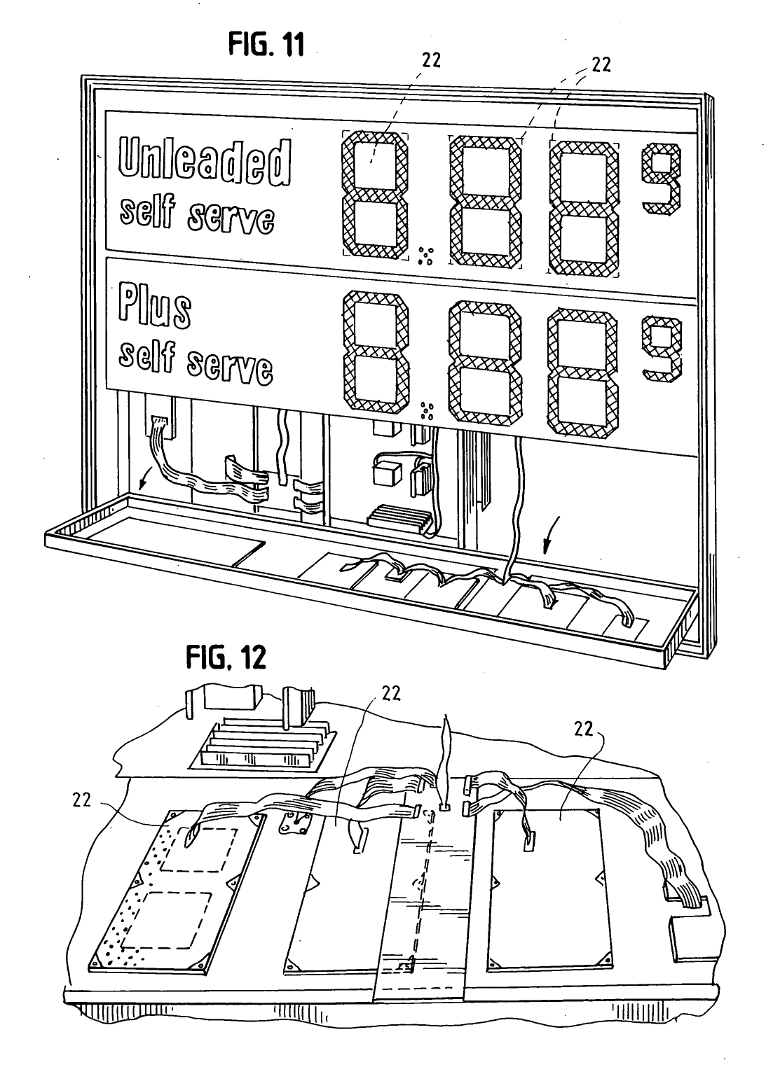

As outlined above, the signs 20 also include LED panels 22 including a substrate 35 and a field of light emitting diodes 36, as shown in FIGS. 9 and 10. Controls (now shown) and ribbon cable connections energize selected diodes to produce the desired numbers to define a price. Although the signs 20 include a combination of display assemblies 23 and LED panels 22, they may alternatively include numeric displays that combine a scrolling strip printed with numbers and an illuminating member and an illuminated body for providing back light for the scrolling strip. This alternative would eliminate the LED panels.

While the above description and the drawings disclose and illustrate one embodiment and a number of modifications, one should understand, of course, that the invention is not limited to this embodiment and modifications. Those skilled in the art to which the invention pertains may make other modifications and other embodiments employing the principles of this invention, particularly upon considering the foregoing teachings. Therefore, by the appended claims, the applicant intends to cover any modifications and other embodiments as incorporate those features which constitute the essential features of this invention.

1. An electronic sign apparatus comprising:
an illuminated body including edge portions and at least one face;
an illuminating member disposed along at least one edge portion of the illuminated body for illuminating the illuminated body; and readable indicia disposed opposite the one face of the illuminated body; the illuminated body providing back light for the readable indicia.

2. The apparatus of claim 1, wherein the illuminated body includes a translucent, white tinted plexiglass.

3. The apparatus of claim 1, wherein the illuminating member includes a surface mounted diodes disposed along an edge portions of the illuminated body.

4. The apparatus of claim 3, wherein the illuminating member includes a pair of surface mounted diodes disposed along opposite edge positions of the illuminated body.

5. The apparatus of claim 1, wherein the readable indicia is stationary and includes a printed substrate.

6. The apparatus of claim 1, wherein the substrate is transparent and the printing is colored characters or designs painted on the substrate.

7. The apparatus of claim 1, further comprising a panel member disposed adjacent the illuminated body and a plurality of light emitting members disposed on the panel member.

8. The apparatus of claim 7, wherein the light emitting members include light emitting diodes.

9. An electronic sign apparatus comprising:
a frame;
an illuminated body disposed on the frame and including edge portions and at least one face;
at least one surface mounted diode disposed along an edge position of the illuminated body for illuminating the body;
a substrate disposed on the frame opposite the one face of the illuminated body;
and readable opaque indicia disposed on the substrate, the illuminated body providing back light for the readable indicia.

10. The apparatus of claim 9, wherein the illuminated body includes a translucent white tinted plexiglass.

11. The apparatus of claim 9, wherein the illuminating member includes a pair of surface mounted diodes disposed along opposite edge positions of the illuminated body.

12. The apparatus of claim 9, wherein the substrate is transparent and the indicia includes colored characters or designs painted on the substrate.

13. The apparatus of claim 9, further comprising a panel member disposed adjacent the illuminated body and a plurality of light emitting members disposed on the panel member.

14. The apparatus of claim 13, wherein the light emitting members include light emitting diodes.

15. An electronic sign apparatus comprising:
a frame;
an illuminated body disposed on the frame and including edge portions and at least one face;
at least one surface mounted diode disposed along an edge position of the illuminated body for illuminating the body;
a substrate disposed on the frame opposite the one face of the illuminated body;
readable opaque indicia disposed on the substrate, the illuminated body providing back light for the readable indicia;
a panel member disposed adjacent the illuminated body; and
a plurality of light emitting diodes disposed on the panel members.

16. The apparatus of claim 15, wherein the illuminated body includes a translucent white tinted plexiglass.

17. The apparatus of claim 15, wherein the illuminating member includes a pair of surface mounted diodes disposed along opposite edge positions of the illuminated body.

18. The apparatus of claim 15, wherein the substrate is transparent and the indicia includes colored characters or designs painted on the substrate.
